(19) United States
(12) Patent Application Publication
(10) Pub. No.: US 2025/0345725 A1
(43) Pub. Date: Nov. 13, 2025

(54) HYDRODYNAMIC STORMWATER SEPARATOR

(71) Applicant: CONTECH ENGINEERED SOLUTIONS LLC, West Chester, OH (US)

(72) Inventors: Michael B. BROOKS, Battle Ground, WA (US); Lindsey BLAIRE, Portland, OR (US)

(21) Appl. No.: 19/203,262

(22) Filed: May 9, 2025

Related U.S. Application Data
(60) Provisional application No. 63/645,504, filed on May 10, 2024.

(51) Int. Cl. B01D 21/00; B01D 21/02; E03F 5/14

(52) U.S. Cl. CPC B01D 21/0042; B01D 21/0075; B01D 21/02; E03F 5/14

(57) ABSTRACT

A stormwater separator includes a tank with a bottom wall and an upright sidewall, and an insert configured to divide the internal volume into an inlet region, an interior region and an outlet region. The insert is configured to define multiple flow openings for passage of water between the inlet region and the interior region. The insert is configured to provide at least one outlet opening through which stormwater exiting the interior region passes to reach the outlet region and then the tank outlet opening. Multiple deflector shields extend outwardly from the interior region, each deflector shield having a distal edge portion spaced inwardly from the upright sidewall. At least a first one of the flow openings is located at a height that are above a height of a downwardly angled skirt and below a height at which at least one of the deflector shields abuts to the interior region.

### TECHNICAL FIELD

This application relates generally to separator units with enhanced surface area and texture modification that receive stormwater runoff, and, more particularly, to separator units having high sedimentation, hydrocarbons, floatables and/or debris removal and retention even in the case of high flow rates.

### BACKGROUND

The protection of ground water and natural bodies of water requires systems for diverting and/or treating water that contacts roadways, parking lots, and other man-made structures. A variety of stormwater separation systems exist. These systems generally include a tank or container including a storage or treatment chamber within which, ideally, floating particulates are retained, and non-floating particulates are allowed to settle. The storage chamber includes an inlet for receiving untreated water, and an outlet for movement of treated water out of the chamber. The tank may also include a bypass arrangement to allow excess untreated water to exit the tank without passing through the storage chamber.

U.S. Pat. No. 10,953,412, a copy of which is attached hereto and included as part of the disclosure of this application, discloses one effective hydrodynamic separator. However, improvements in such separators are regularly sought. The need to settle fine particulates has been sought by various agencies and regulatory groups.

Accordingly, it would be desirable to provide an improved separator.

### SUMMARY

In one aspect, a stormwater separator unit includes a tank including an internal volume that is defined at least in part by a bottom wall and an upright sidewall of the tank, the upright sidewall having a tank inlet opening and a tank outlet opening. An insert is within the tank and is configured to divide the internal volume into an inlet region, a central region and an outlet region, wherein the tank inlet opening is into the inlet region, wherein the tank outlet opening is from the outlet region. The insert includes a down cylinder substantially centrally disposed within the tank and a baffle assembly at an external side of the down cylinder. The down cylinder includes a cylindrical wall disposed about the central region. The cylindrical wall includes multiple cylinder flow openings for passage of stormwater between the inlet region and the central region. The cylindrical wall includes at least one cylinder outlet opening through which stormwater exiting the central region passes to reach the outlet region and then the tank outlet opening. The insert further comprises multiple deflector shields extending outwardly from the cylindrical wall, each deflector shield extending toward the upright sidewall and having a distal edge spaced inwardly from the upright sidewall. Each deflector shield extends annularly about at least a portion of the cylindrical wall. The deflector shields are spaced apart from each other along a height of the cylindrical wall. The insert further comprises a downwardly angled skirt extending outwardly from a bottom portion of the cylindrical wall, the downwardly angled skirt having a distal edge portion spaced inwardly from the upright wall. A multiplicity of the cylinder flow openings are located at respective heights that are above a height of the downwardly angled skirt and below a height at which a lowermost one of the deflector shields is joined to the cylindrical wall. The insert includes an outlet deck below the tank outlet opening, a drain down opening in the outlet deck and a drain down pipe extending downwardly from the drain down opening. A bottom of the drain down pipe is located at a height that is lower than a height at which an uppermost one of the deflector shields is joined to the cylindrical wall.

In another aspect, a stormwater separator unit includes a tank including an internal volume that is defined at least in part by a bottom wall and an upright sidewall of the tank, the upright sidewall having a tank inlet opening and a tank outlet opening. An insert is within the tank and is configured to divide the internal volume into an inlet region, an interior region and an outlet region, wherein the tank inlet opening is into the inlet region, wherein the tank outlet opening is from the outlet region. The insert includes an upright tubular disposed within the tank and a baffle assembly at an external side of the upright tubular. The upright tubular includes a tubular wall disposed about the interior region. The tubular wall includes multiple flow openings for passage of water between the inlet region and the interior region. The upright tubular includes at least one outlet opening through which stormwater exiting the interior region passes to reach the outlet region and then the tank outlet opening. The insert further comprises multiple deflector shields extending outwardly from the tubular wall, each deflector shield having a distal edge portion spaced inwardly from the upright sidewall. Each deflector shield extends annularly about at least a portion of the tubular wall. The deflector shields are spaced apart from each other along a height of the tubular wall. The insert further comprises a downwardly angled skirt extending outwardly from a bottom portion of the tubular wall, the downwardly angled skirt having a distal edge portion spaced inwardly from the upright wall. One or more of the flow openings are located at respective heights that are above a height of the downwardly angled skirt and below a height at which at least one of the deflector shields is joined to the tubular wall. The insert is configured such that the outlet region comprises an outlet zone around the tank outlet opening. A drain down pipe is positioned and configured for enabling drain down of the inlet region during no flow conditions. A bottom of the drain down pipe is located at a height that is lower than a height at which an uppermost one of the deflector shields is joined to the tubular wall.

In yet another aspect, a stormwater separator unit includes a tank including an internal volume that is defined at least in part by a bottom wall and an upright sidewall of the tank, the upright sidewall having a tank inlet opening and a tank outlet opening. An insert is within the tank and is configured to divide the internal volume into an inlet region, an interior region and an outlet region, wherein the tank inlet opening is into the inlet region, wherein the tank outlet opening is from the outlet region. The insert is configured to define multiple flow openings for passage of water between the inlet region and the interior region. The insert is configured to provide at least one outlet opening through which stormwater exiting the interior region passes to reach the outlet region and then the tank outlet opening. The insert further comprises multiple deflector shields extending outwardly from the interior region, each deflector shield having a distal edge portion spaced inwardly from the upright sidewall. Each deflector shield extends annularly about at least a portion of the interior region. The deflector shields are spaced apart from each other along a height of the interior region. The insert further comprises a downwardly angled skirt extending outwardly from a bottom portion of the interior region, the downwardly angled skirt having a distal edge portion spaced inwardly from the upright wall. At least one of the flow openings is located at a height that is above a height of the downwardly angled skirt and below a height at which at least one of the deflector shields abuts to the interior region.

The details of one or more embodiments are set forth in the accompanying drawings and the description below. Other features, objects, and advantages will be apparent from the description and drawings, and from the claims.

### BRIEF DESCRIPTION OF THE DRAWINGS

FIGS. 1, 3 and 4 show perspective views of a hydrodynamic separator, with tank wall depicted transparent;

FIG. 2 is a cross-section of the hydrodynamic separator; and

FIG. 5 is a perspective view of a tank insert with texture enhanced surface portions.

### DETAILED DESCRIPTION

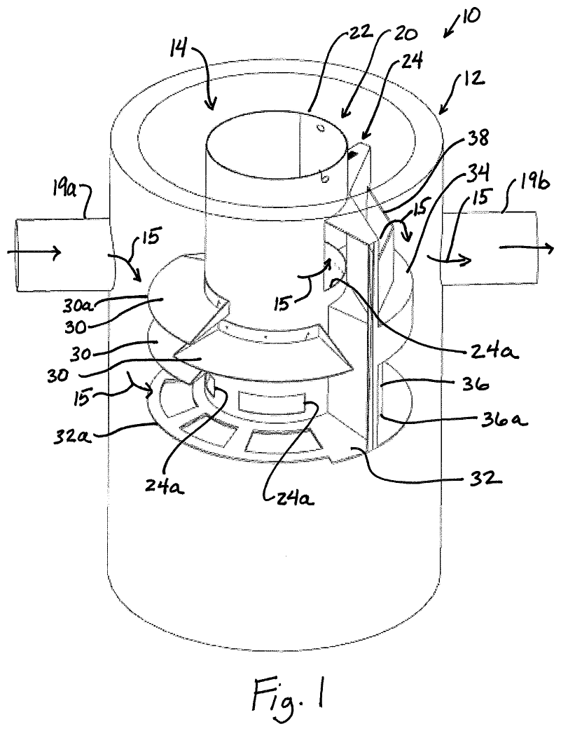

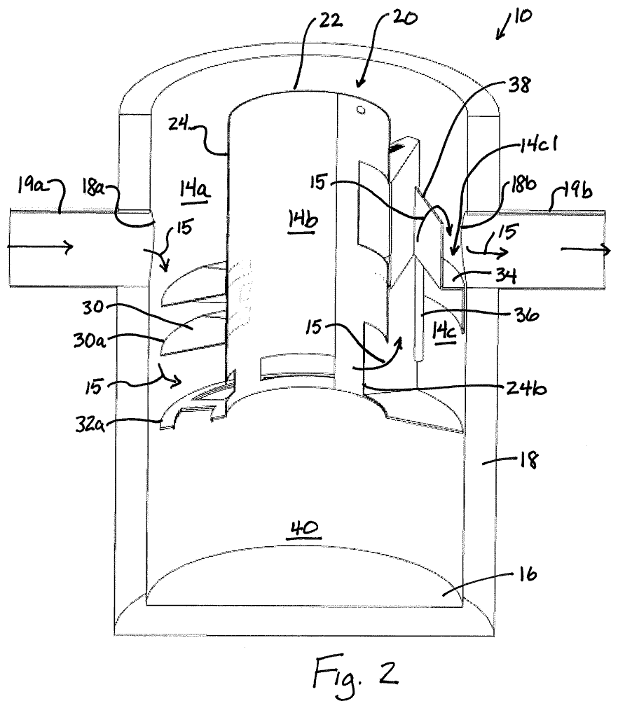

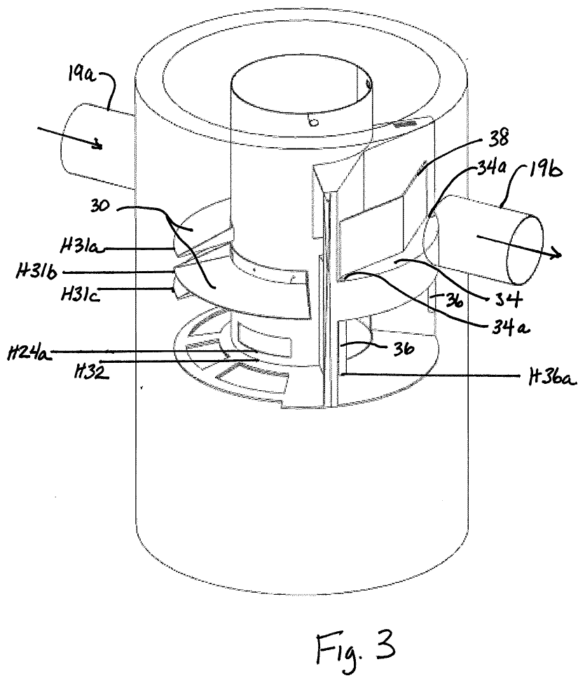

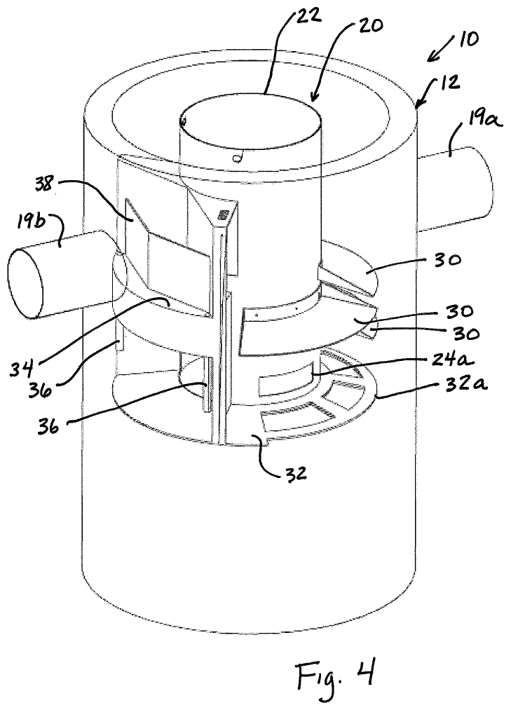

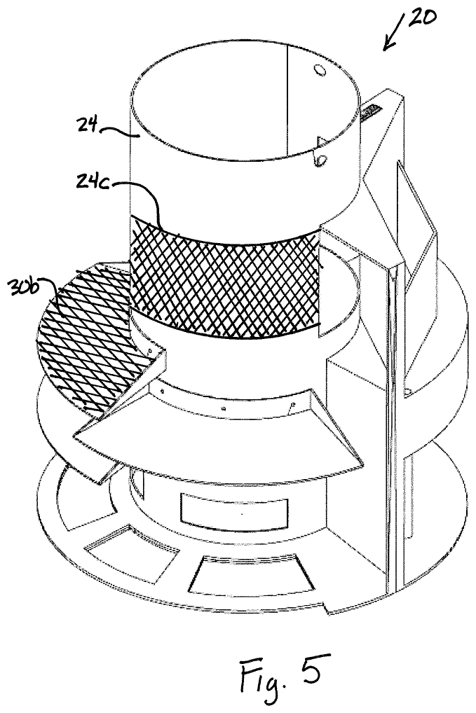

Referring to FIGS. 1-4, a stormwater separator unit 10 includes a tank 12 (e.g., a cylindrical concrete manhole) having an internal volume 14 that is defined at least in part by a bottom wall 16 and an upright sidewall 18 of the tank. The upright sidewall 18 includes a tank inlet opening 18a and a tank outlet opening 18b, with respective inlet pipe 19a and outlet pipe 19b. Additional tank inlet openings may be provided, and inlet openings from a top wall or lid (not shown) may also be provided.

An insert 20 is located within the tank and is configured to divide the internal volume 14 into an inlet region 14a, an internal region 14b and an outlet region 14c. Here, the internal region 14b is a region substantially centered within the tank. The tank inlet opening 18a is into the inlet region 14a, and the tank outlet opening 18b is from the outlet region 14c.

Here, the insert includes a down cylinder 22 (or other upright tubular) substantially centrally disposed within the tank 12 and a baffle assembly 24 at an external side of the down cylinder 22. The down cylinder 22 includes a cylindrical (or other tubular) wall 24 disposed about the internal region 14b. The tubular wall 24 includes multiple flow openings 24a for passage of stormwater between the inlet region 14a and the internal region 14b, and at least one outlet opening 24b through which stormwater exiting the central region 14b passes to reach the outlet region 14c and then the tank outlet opening 18b.

Multiple deflector shields 30 extend outwardly from the tubular wall 24, and thus outwardly from the internal region 14b. Each deflector shield extends toward the upright sidewall 18 and has a distal edge portion 30a spaced inwardly from the upright sidewall 18. Each deflector shield 30 extends annularly about at least a portion of the tubular wall 24, and thus annularly about a portion of the internal region 14b. As shown, the deflector shields 30 are spaced apart from each other along a height of the tubular wall, and thus are also spaced apart from each other along the height of the internal region 14b. In implementations, the deflector shields angle downwardly.

The insert 20 further includes a downwardly angled skirt 32 extending outwardly from a bottom portion of the tubular wall 24, and thus outwardly from a bottom portion of the internal region 14b. The downwardly angled skirt includes a distal edge portion 32a spaced inwardly from the upright wall 18.

A multiplicity of the flow openings 24a are located at respective heights (e.g., H 24a) that are above a height H 32 of the downwardly angled skirt 32 and below heights H31a, H 31b and H 31c at which the deflector shields are joined to the tubular wall 24 or abut the internal region 14b.

Here, the insert 20 includes an outlet deck 34 below the tank outlet opening 18b, which in part defines an outlet zone 14cl (of the outlet region 14c) about the outlet opening 18b. One or more drain down openings 34a are located in the outlet deck 34, with respective drain down pipes 36 extending downwardly from the drain down openings. Here, a bottom 36a of each drain down pipe 36 is located at a height H 36a that is lower than the height H 31a at which the uppermost one of the deflector shields 30 is joined to the tubular wall 24 or at which the uppermost deflector shield 30 abuts the internal region 14b.

Here, the insert 20 further includes a weir wall 38 over which stormwater flows to reach the outlet opening 18b. The weir wall further defines the outlet zone 14cl about the outlet opening 18b.

During flow through the separator (into the inlet region 14a, then to the interior region 14b and then to the outlet region 14c, per arrows 15), particles in the water tend to settle in a sump region 40 at the bottom of the tank.

In some embodiments, one or more of the deflector shields 30 includes a texture enhanced surface portion or portions 30b. The textured enhanced surface portion may increase the overall surface area which can enhance settling and limit resuspension.

In some embodiments, at least part of an outer surface portion of the tubular wall 24 is a texture enhanced surface portion 24c. The texture enhanced surface portion may disrupt flow and assists in surface settling of finer particles. The textured surface may also create riffles creating turbulent water.

In some embodiments, a flow within the internal region 14b may be a dual vortex flow (e.g., as a result of opposed inlet flumes of the insert).

It is to be clearly understood that the above description is intended by way of illustration and example only, is not intended to be taken by way of limitation, and that other changes and modifications are possible.

1. A stormwater separator unit, comprising:
a tank including an internal volume that is defined at least in part by a bottom wall and an upright sidewall of the tank, the upright sidewall having a tank inlet opening and a tank outlet opening;
an insert within the tank and configured to divide the internal volume into an inlet region, a central region and an outlet region, wherein the tank inlet opening is into the inlet region, wherein the tank outlet opening is from the outlet region;
wherein the insert includes a down cylinder substantially centrally disposed within the tank and a baffle assembly at an external side of the down cylinder;
wherein the down cylinder includes a cylindrical wall disposed about the central region;
wherein the cylindrical wall includes multiple cylinder flow openings for passage of stormwater between the inlet region and the central region;
wherein the cylindrical wall includes at least one cylinder outlet opening through which stormwater exiting the central region passes to reach the outlet region and then the tank outlet opening;
wherein the insert further comprises multiple deflector shields extending outwardly from the cylindrical wall, each deflector shield extending toward the upright sidewall and having a distal edge spaced inwardly from the upright sidewall;
wherein each deflector shield extends annularly about at least a portion of the cylindrical wall;
wherein the deflector shields are spaced apart from each other along a height of the cylindrical wall;
wherein the insert further comprises a downwardly angled skirt extending outwardly from a bottom portion of the cylindrical wall, the downwardly angled skirt having a distal edge portion spaced inwardly from the upright wall;
wherein a multiplicity of the cylinder flow openings are located at respective heights that are above a height of the downwardly angled skirt and below a height at which a lowermost one of the deflector shields is joined to the cylindrical wall;
wherein the insert includes an outlet deck below the tank outlet opening, a drain down opening in the outlet deck and a drain down pipe extending downwardly from the drain down opening;
wherein a bottom of the drain down pipe is located at a height that is lower than a height at which an uppermost one of the deflector shields is joined to the cylindrical wall.

2. The stormwater separator unit of claim 1, wherein:
one or more of the deflector shields includes a texture enhanced surface portion;
and/or
at least part of an outer surface portion of the down cylinder is a texture enhanced surface.

3. The stormwater separator unit of claim 1, wherein the insert further includes a weir wall over which stormwater flows to reach the outlet opening.

4. The stormwater separator unit of claim 1, wherein at least one of the cylinder flow openings is located above the height at which the lowermost one of the deflector shields is joined to the cylindrical wall.

5. A stormwater separator unit, comprising:
a tank including an internal volume that is defined at least in part by a bottom wall and an upright sidewall of the tank, the upright sidewall having a tank inlet opening and a tank outlet opening;
an insert within the tank and configured to divide the internal volume into an inlet region, an interior region and an outlet region, wherein the tank inlet opening is into the inlet region, wherein the tank outlet opening is from the outlet region;
wherein the insert includes an upright tubular disposed within the tank and a baffle assembly at an external side of the upright tubular;
wherein the upright tubular includes a tubular wall disposed about the interior region;
wherein the tubular wall includes multiple flow openings for passage of water between the inlet region and the interior region;
wherein the upright tubular includes at least one outlet opening through which stormwater exiting the interior region passes to reach the outlet region and then the tank outlet opening;
wherein the insert further comprises multiple deflector shields extending outwardly from the tubular wall, each deflector shield having a distal edge portion spaced inwardly from the upright sidewall;
wherein each deflector shield extends annularly about at least a portion of the tubular wall;
wherein the deflector shields are spaced apart from each other along a height of the tubular wall;
wherein the insert further comprises a downwardly angled skirt extending outwardly from a bottom portion of the tubular wall, the downwardly angled skirt having a distal edge portion spaced inwardly from the upright wall;
wherein a multiplicity of the flow openings are located at respective heights that are above a height of the downwardly angled skirt and below a height at which at least one of the deflector shields is joined to the tubular wall;
wherein the insert is configured such that the outlet region comprises an outlet zone around the tank outlet opening;
wherein a drain down pipe is positioned and configured for enabling drain down of the inlet region during no flow conditions;
wherein a bottom of the drain down pipe is located at a height that is lower than a height at which an uppermost one of the deflector shields is joined to the tubular wall.

6. The stormwater separator unit of claim 5, wherein the upright tubular comprises a tubular cylinder.

7. The stormwater separator unit of claim 5, wherein
one or more of the deflector shields includes a texture enhanced surface portion;
and/or
at least part of an outer surface portion of the upright tubular is a texture enhanced surface.

8. The stormwater separator unit of claim 5, wherein the insert further includes a weir wall over which stormwater flows to reach the outlet opening.

9. The stormwater separator unit of claim 5, wherein at least one of the cylinder flow openings is located above the height at which the at least one of the deflector shields is joined to the tubular wall.

10. A stormwater separator unit, comprising:
a tank including an internal volume that is defined at least in part by a bottom wall and an upright sidewall of the tank, the upright sidewall having a tank inlet opening and a tank outlet opening;
an insert within the tank and configured to divide the internal volume into an inlet region, an interior region and an outlet region, wherein the tank inlet opening is into the inlet region, wherein the tank outlet opening is from the outlet region;
wherein the insert is configured to define multiple flow openings for passage of water between the inlet region and the interior region;
wherein the insert is configured to provide at least one outlet opening through which stormwater exiting the interior region passes to reach the outlet region and then the tank outlet opening;
wherein the insert further comprises multiple deflector shields extending outwardly from the interior region, each deflector shield having a distal edge portion spaced inwardly from the upright sidewall;
wherein each deflector shield extends annularly about at least a portion of the interior region;
wherein the deflector shields are spaced apart from each other along a height of the interior region;
wherein the insert further comprises a downwardly angled skirt extending outwardly from a bottom portion of the interior region, the downwardly angled skirt having a distal edge portion spaced inwardly from the upright wall;
wherein at least a first one of the flow openings is located at a height that is above a height of the downwardly angled skirt and below a height at which at least one of the deflector shields abuts to the interior region.

11. The stormwater separator unit of claim 10,
wherein the insert is configured such that the outlet region comprises an outlet zone around the tank outlet opening;
wherein the separator unit further comprises a drain down pipe having a first end within the outlet zone and a second end outside of the outlet zone.

12. The stormwater separator unit of claim 10, wherein the second end of the drain down pipe is located at a height that is lower than a height at which an uppermost one of the deflector shields abuts the interior region.

13. The stormwater separator of claim 10, wherein:
one or more of the deflector shields having a texture enhanced surface portion;
and/or
at least part of an outer surface portion of the upright tubular is a texture enhanced surface.

14. The stormwater separator unit of claim 10, wherein the insert further includes a weir wall over which stormwater flows to reach the outlet opening.

15. The stormwater separator unit of claim 10, wherein at least a second one of the flow openings is located above the height at which the at least one of the deflector shields abuts to the interior region.
